(19) United States
(12) Patent Application Publication
(10) Pub. No.: US 2014/0344538 A1
(43) Pub. Date: Nov. 20, 2014

(54) SYSTEMS, METHODS, AND COMPUTER PROGRAM PRODUCTS FOR DETERMINING BLOCK CHARACTERISTICS IN A COMPUTER DATA STORAGE SYSTEM

(71) Applicant: Netapp, Inc., Sunnyvale, CA (US)

(72) Inventors: Dnyaneshwar Pawar, Bangalore (IN); Sudhanshu Gupta, Bangalore (IN); Satbir Singh, Bangalore (IN)

(73) Assignee: NETAPP, INC., Sunnyvale, CA (US)

(21) Appl. No.: 13/894,337

(22) Filed: May 14, 2013

(51) Int. Cl. G06F 3/06

(52) U.S. Cl. CPC G06F 3/065; G06F 3/0604; G06F 3/0683
USPC 711/162

(57) ABSTRACT

Systems, methods, and non-transitory machine readable media for determining block characteristics include one or more processors, a memory for storing instructions for the one or more processors, persistent storage, and a file system implemented in the persistent storage and storing data in the persistent storage using a plurality of blocks. When the stored instructions are executed by the one or more processors, the one or more processors are configured to traverse the plurality of blocks, read contents of a first block selected from the plurality of blocks, determine one or more characteristics of the first block from metadata within the block, and selectively perform or not perform a storage operation with respect to the first data block in response to determining the one or more characteristics. In some embodiments, the storage operation is a replication operation or a deduplication operation.

### TECHNICAL FIELD

The present disclosure relates, generally, to computer data storage systems and, more specifically, to techniques for determining block characteristics in a computer data storage system.

### BACKGROUND

In a computer data storage system which provides data storage and retrieval services, the data storage system may implement data structures and drivers to functionally organize data access services of the system, and to implement the file system that organizes data being stored, retrieved, and managed in the data storage system. Many data storage systems and their file systems organize data using files and other storage structures. The use of files and other storage structures provides a logical way to organize data in the data storage system because each of the files may represent a collection of related data as often considered from the perspective of a user. And while the use of files and other storage structures is a useful approach, in data storage systems where files are constantly being changed, moved, copied, and/or deleted, the files and other storage structures may be divided into manageable units called blocks, where each file or other storage structure may use many blocks.

The use of blocks often supports flexible use of the data storage system as the amount of data being stored increases and decreases with use of the data storage system. The blocks associated with a particular file may be stored in different areas of the data storage system because it is often not practical to store every file, especially large files, in consecutive blocks. The blocks may store many different kinds of data and/or metadata depending on the data structures used by the data storage system to locate and identify data. In some systems, the blocks may be organized hierarchically into levels to more effectively handle files and other storage structures requiring a small number or a very large number of blocks. Thus, blocks are a convenient way to review and/or examine data in the data storage system based on where the data is physically stored, whereas files are a convenient way to review and/or examine the data based on how it is logically organized.

In data storage systems that use blocks, the utilities and applications that work with the data stored at the block level may often consult a special metafile describing characteristics of the blocks including an indirection level and type for each of the blocks. This special metafile may be quite large and often incurs extra activity by the utilities and applications when they take time to read the contents of the special metafile. The utilities and applications are also susceptible to errors or long delays when the special metafile contains erroneous information.

Several examples of utilities or applications that often work with data stored at the block level are one or more kinds of data replication. One kind of data replication is data minoring, where data is copied to another physical (destination) site and continually updated so that the destination site has an up to date copy, or nearly up to date copy, of the data as the data changes on the originating (source) system. Another kind of data replication is data backup, where old versions of the data are periodically stored. Whether data is mirrored or backed-up, the replicated data can be used to recover from a loss of data at the source. A user simply accesses the most recent data saved, rather than starting from scratch.

In some systems, snapshots may be used to support data replication. In short, a snapshot represents the state of a file system at a particular point in time. As the active file system (e.g., the file system actively responding to client requests for data access) is modified, it diverges from the most recent snapshot. When the next snapshot is taken, the active file system is copied and becomes the most recent snapshot. Subsequent snapshots can be created indefinitely, as often as desired, which leads to more and more old snapshots being saved to the system.

Other examples of utilities or applications that often work with data stored at the block level are those used for improving the use and/or storage in the data storage system. In some systems, defragmentation may be used to store all the blocks of a file or other storage structures in contiguous locations of a storage media used by the data storage system. In some systems, deduplication may be used to identify blocks with the same content so that only a single copy of that block is stored and duplicate copies may be removed.

Many kinds of data duplication and the other tools use knowledge of one or more characteristics of each of the blocks in the data storage system in order to efficiently complete their tasks. Accordingly, it would be advantageous to have improved systems and methods for determining characteristics of each of the blocks including the level and type of each of the blocks.

### BRIEF DESCRIPTION OF THE DRAWINGS

The present disclosure is best understood from the following detailed description when read with the accompanying figures.

FIG. 1 is a simplified diagram of a storage system according to some embodiments.

FIG. 2 is a simplified diagram of a file system implemented in a storage system according to some embodiments.

FIG. 3 is a simplified diagram showing a representative method of snapshot creation using a block metafile according to some embodiments.

FIG. 4 is a simplified diagram showing a representative method of snapshot creation without using a block metafile according to some embodiments.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional. This repetition is for the purpose of simplicity and clarity and does not in itself dictate a relationship between the various embodiments and/or configurations discussed.

Many utilities and applications that work with a data storage system systematically review and/or examine all the data stored in the data storage system. For some of these utilities and applications, the data may be reviewed and/or examined at the file level where a respective utility and/or application may consider each file in order. Such an approach often makes sense when the utility or application is presenting information to a user. For some of these utilities and applications it makes more sense to review and/or examine the data block by block because the blocks can be systematically reviewed in the order in which they are stored in the data storage system. However, when the data is considered block by block, it is not generally apparent which file, if any, the block is associated with or the type of data stored in the block.

In order to determine the characteristics of a block, the utilities and applications that work with the data stored in a file system at the block level often may consult a special metafile describing characteristics of each of the blocks. Some examples of useful block characteristics include an indirection level and a type of each of the blocks. The indirection level indicates, in part, whether the block includes data from the file or describes how to find the blocks containing the data. The type indicates, among other things, whether the block includes user data, metadata, or other types of data stored in the data storage system. This special metafile may be quite large and may slow down the utilities and applications because they take time to read the contents of the special metafile. The utilities and applications may also be susceptible to errors or long delays when the special metafile is corrupt or contains erroneous information. In most cases, the utilities and applications may successfully learn the characteristics of each block, including the indirection level and type, based on the contents of each block stored in the file system. Thus, some systems may avoid reading the special metafile. Using the block characteristics determined from the contents of the block, the utilities and applications may make intelligent decisions regarding which blocks are of interest and/or may result in further processing.

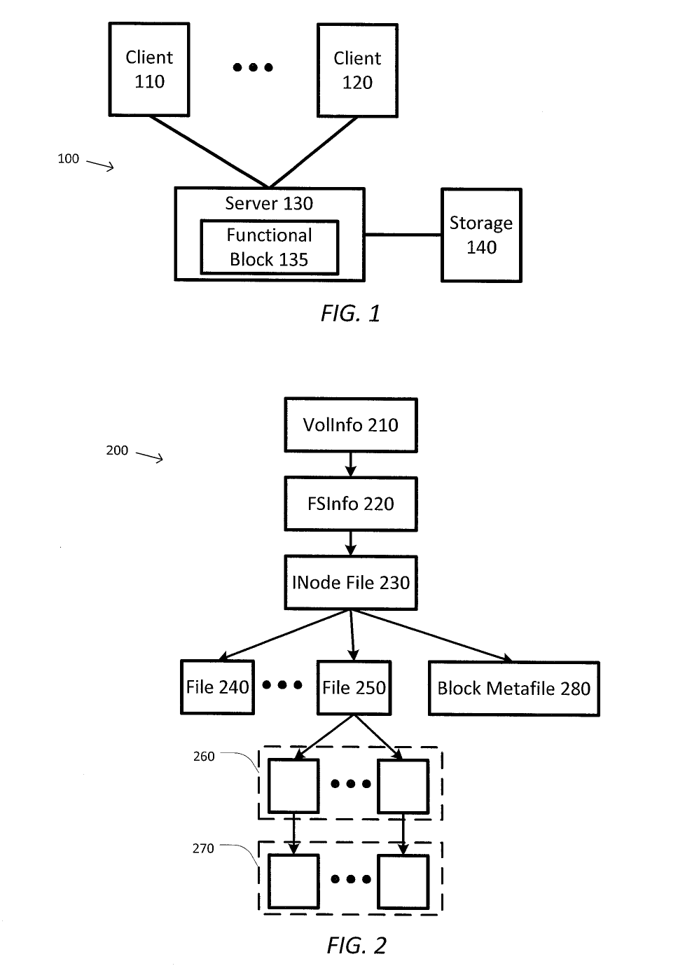

FIG. 1 is a simplified diagram of a storage system 100 according to some embodiments. Storage server 130 is coupled to a persistent storage subsystem 140 and to a set of clients 110, 120. Each of the clients 110, 120 may include, for example, a personal computer (PC), server computer, a workstation, a handheld computing/communication device or tablet, and/or the like or may represent an application executing on a PC, a server computer, a handheld computing/communication device or tablet, and/or the like. FIG. 1 shows only two clients 110 and 120, but the scope of embodiments may include any appropriate number of clients. Although not shown, the clients 110, 120 may be coupled to the storage server 130 using one or more networks. In some examples, the one or more networks may include a local area network (LAN), wide area network (WAN), the Internet, a Fibre Channel fabric, or any combination of such interconnects.

One or more of the clients 110, 120 may act as a management station in some embodiments. Such a client may include management application software that is used by an administrator to configure storage server 130, to provision storage in persistent storage subsystem 140, and to perform other management functions related to the storage system 100, such as scheduling backups, setting user access rights, and the like.

The storage server 130 manages the storage of data in the persistent storage subsystem 140. The storage server 130 handles read and write requests from the clients 110, 120, where the requests are directed to data stored in or to be stored in the persistent storage subsystem 140. The storage server 130 may also include one or more functional units 135. Each of the one or more functional units 135 may be used by the storage server 130 to support one or more of the management tasks and/or requests handled by the storage server 130. In some examples, one or more of the functional units 135 may support replication, defragmentation, and/or deduplication. In some examples, the one or more functional units 135 may determine and/or use characteristics of blocks used to store data in the storage system 100. In some examples, the block characteristics may include an indirection level and/or a type of data in the blocks. In some examples, the storage server 130 may be running one or more storage operating systems. In some examples, the one or more storage operating systems may include a Data ONTAP™ operating system from NetApp, Inc. In some examples, the one or more operating systems may use the one or more functional units 135.

Persistent storage subsystem 140 is not limited to any particular storage technology and can use any storage technology now known or later developed. In some examples, persistent storage subsystem 140 may include a number of nonvolatile mass storage devices (not shown), which may include conventional magnetic or optical disks or tape drives; non-volatile solid-state memory, such as flash memory; or any combination thereof. In some examples, the persistent storage subsystem 140 may include one or more RAIDs.

The storage server 130 may allow data access according to any appropriate protocol or storage environment configuration. In some examples, storage server 130 may provide file-level data access services to clients 110, 120. In some examples, storage server 130 may provide block-level data access services to clients 110, 120. In some examples, storage server 130 may provide both file-level and block-level data access services to clients 110, 120. Although not shown, storage server 130 may include memory and/or one or more processors.

Storage system 100 is shown as an example only. Other types of hardware and software configurations may be adapted for use according to the features described herein.

For example, some embodiments of the storage server 130 and/or the clients 110, 120 may include non-transient, tangible machine-readable media that include executable code that when run by one or more processors, may cause the one or more processors to perform the steps of methods described herein. Some common forms of machine readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 2 is a simplified diagram of a file system 200 implemented in a storage system according to some embodiments. As shown in FIG. 2, the file system 200 includes a way to organize data to be stored, retrieved, and/or managed by the storage system. In some examples, the storage system may be the storage system 100. In some examples, the storage system may include a storage server (e.g., the storage server 130 including the one or more functional blocks 135). In some examples, the storage server may use the file system 200 as it manages the storage system and carries out various operations of the storage system as requested by clients of the storage system to save and/or retrieve data within file system 200. At the top level of file system 200 is volume information or VolInfo 210. VolInfo 210 is a base node of a buffer tree that describes the organization of the file system 200. VolInfo 210 includes a pointer to the file system information or FSInfo 220 of the file system 200. In some examples, the VolInfo 210 may also include data describing the volume including the size of the volume, volume level options, language, etc. Although FIG. 2 depicts only one volume (i.e., only one VolInfo 210), it is understood that the file system 200 may include multiple volumes.

FSInfo 220 includes pointers to an mode file 230. Inode file 230 includes data structures with information about files and/or other storage structures stored in the file system 200, which will be referred to as files without loss of generality. In some examples, the mode file 230 may be consistent with Unix and/or other file systems. In the file system 200, each file is assigned an mode and is identified by an mode number (i-number) in the file system 200 where it resides. Inodes provide important information about files such as user and group ownership, access mode (read, write, execute permissions) and type. In some examples, the persistent storage (e.g., the persistent storage 140) of the file system 200 may be divided into a large number of blocks of a standard size, where the Mode identifies blocks where the file is stored in the file system 200. In some examples, the standard size is 4,096 bytes or 4 kB per block.

Depending upon the size and/or arrangement of the blocks in a file, the blocks identified by the Mode may include blocks with data from the file and/or indirect blocks that in turn may identify other blocks with data and/or additional indirect blocks. Inode file 230 describes either directly and/or indirectly which blocks are used by each file. The Mode file 230 is described by the FSInfo 220, which acts a special root mode for the file system 200.

File system 200 is arranged hierarchically, with VolInfo 210 on the top level of the hierarchy, FSInfo 220 right below VolInfo 210, and Mode file 230 below FSInfo 220. The hierarchy includes further components at lower levels. Each Mode in the Mode file 230 identifies a highest-level block for a corresponding file. As shown in FIG. 2, the Mode file 230 includes an mode that identifies a file block 240 and a file block 250 for two files, although is understood that the Mode file 230 may include Modes for many more than just two files. At the lowest level, referred to herein as level zero or L0, are blocks with data, which may include user data, metadata, and other data stored by the file system 200. Between Mode file 230 and the blocks with data, there may be one or more levels of indirect blocks. This is depicted in greater detail for the file with the file block 250. As shown, the file block 250 identifies indirect blocks 260, which in turn identify data blocks 270.

However, while FIG. 2 shows only a single level of indirect blocks 260 with a fanout of one, it is understood that any given file may include more than one hierarchical level of indirect blocks 260, which by virtue of pointers and multiple levels eventually lead to data blocks 270. By further allowing each indirect block 260 to fan out to multiple data blocks 270 and/or additional levels of indirect blocks 260, a total number of data blocks 270 associated with a file may grow geometrically at each level. In order to be able to work within the hierarchy of indirect blocks 260, it may be useful to know an indirection level for each of the indirect blocks 260. In some examples, the indirection level for indirect blocks 260 that point only to data blocks 270 may be one. In some examples, the indirection level for indirect blocks 260 that point to other indirect blocks 260 may be determined based on the number of layers of indirect blocks 260 between a corresponding indirect block 260 and the data blocks 270. In some examples, data blocks 270 may have an indirection level of zero.

The file system 200 further includes a block metafile 280. In some embodiments, the block metafile 280 may be a special file used by the file system 200 to keep track of how each of the blocks in the file system 200 may be used. In some examples, the block metafile 280 may include one or more characteristics of each of the blocks in the file system 200. In some examples, the block characteristics may include an indirection level for each of the blocks so that it is known whether the block is a LO block (e.g., the data blocks 270 having an indirection level of zero) or some other indirect block (e.g., the indirect blocks 260 and/or the file block 250). In some examples, the block characteristics may include an indicator of whether each of the blocks is currently being used by the file system 200. In some examples, the block characteristics may include information on the type of data in each of the blocks. In some examples, the block metafile 280 may include separate files for the different kinds of characteristics stored in the block metafile 280.

The file system 200 may support many different types of data in each of the blocks. In some examples, user data may be assigned a type of “regular.” In some examples, directory information such as directory names, directory data, namespaces, folders, and the like may be assigned a type of “directory.” In some examples, some metadata such as user tagged metadata may be assigned a type of “stream” and directory information for the stream data may be assigned a type of “streamdir.” In some examples, additional file system metadata may be assigned different types such as “xinode” for access control lists, “volinfo” for VolInfo 210, “fsinfo” for FSInfo 220, “inofile” for inode file 230, and the like. In some examples, the block metafile 280 and other kinds of metafiles may each be assigned corresponding types. In some examples, blocks associated with virtual disks may be assigned a type of “vdisk.” Of course, the above-described types are for example only, and the scope of embodiments includes any appropriate number and variety of types and names of types.

Depending upon a number of levels supported by the file system and a number of types of data in the blocks, each block in the file system 200 may use several bits of storage in the block metafile 280 to store the block characteristics. In some examples, each block may use 8 bits of storage in the block metafile 280. Although not shown in FIG. 2, the block metafile 280 may be stored like any other file in the file system 200 and could include one or more levels of indirect blocks. For example, if the file system 200 is used for a 1 TB volume using 4 kB blocks, the block metafile 280 may include block characteristics for over 268 million blocks (1 TB/4 kB) and would employ at least 65,536 data blocks (1 TB/4 kB/4 kB) just to store the 8 bits per block and would also employ any additional indirect blocks used to point to the 65,536 data blocks.

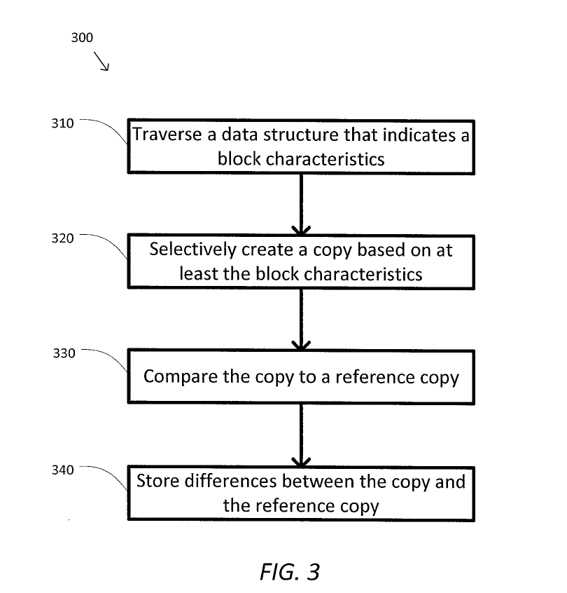

FIG. 3 is a simplified diagram showing a representative method 300 of snapshot creation using a block metafile according to some embodiments. As shown in FIG. 3, the method 300 includes a process 310 for traversing a data structure that indicates block characteristics, a process 320 for selectively creating a copy based on at least the block characteristics, a process 330 for comparing the copy to a reference copy, and a process 340 for storing differences between the copy and the reference copy. According to certain embodiments, the method 300 of snapshot creation using a block metafile can be performed using variations among the processes 310-340 as would be recognized by one of ordinary skill in the art. In some embodiments, one or more of the processes 310-340 of method 300 may be implemented, at least in part, in the form of executable code stored on non-transient, tangible, machine readable media that when run by one or more processors (e.g., one or more processors associated with the storage server 130 and/or one or more processors associated with the clients 110, 120) may cause the one or more processors to perform one or more of the processes 310-340. For example, in some embodiments one or more of the functional blocks 135 (FIG. 1) may perform method 300.

At the process 310, a data structure that indicates block characteristics is traversed. In some examples, the block characteristics may include an indirection level of each block and/or a type of data in each block In some examples, a snapshot tool or utility may traverse the data structure in order to create a snapshot of all or part of a file system. In some examples, the snapshot tool or utility may be one of the clients 110, 120. In some examples, the snapshot tool or utility may be included as a service of the storage server 130 using, for example, one or more of the functional blocks 135. In some examples, the data structure may be the block metafile 280. By traversing the data structure that indicates the block characteristics, the snapshot tool or utility may identify those blocks that are a necessary part of a snapshot or a related data replication activity.

At the process 320, a copy based on at least the block characteristics is selectively created. Depending on the purpose of the snapshot or the data replication, it is not necessary to create a copy of each of the blocks in the file system. In some examples, some snapshots may only be used temporarily and may be used to provide a comparison with a previous version so that a difference can be calculated and sent to a data destination (e.g., for data mirroring). In some examples, the snapshot tool may be configured to remove as much user data and metadata as possible, leaving only the minimum amount of data or metadata sufficient to perform a desired function. In some examples, the data and metadata to be included in the snapshot may be designated by a user and/or a configuration tool.

In some examples, the snapshot tool may selectively omit data and metadata from the snapshot by traversing the block metafile 280. As the snapshot tool traverses the block metafile 280, it may use the included block characteristics, such an indirection level and/or type information stored therein to select which blocks are to be copied for the snapshot. The amount and type of data omitted from the snapshot depends on the purpose for which the snapshot is created. In some examples, in a physical replication, where a block-to-block copy of the volume is created at a destination, less metadata may be included by the replication application. In some examples, the physical replication may limit metadata to blocks with types associated with the volume information, file system information, and the block metafile. In some examples, in a logical replication, more of the metadata may be included to recreate a logically similar (though physically different) storage structure at a destination. In some examples, the logical replication may include additional metadata for the directory and stream directory information. In some examples, the logical replication may include regular, stream, and vdisk blocks of any indirection level.

Because the block metafile 280 includes the block characteristics such as the level and type information for each of the blocks, the process 320 may use the information contained therein to select which blocks are to be selectively copied as part of the snapshot.

At the process 330, the copy is compared to a reference copy. In some examples, it may be more efficient to record only the differences between a current snapshot and a previous snapshot. In order to determine whether there has been a change between the current snapshot and the previous snapshot, the copy of the block made during the process 320 is compared to a reference copy of the same block from the previous snapshot.

At the process 340, the differences between the copy and the reference copy are stored. Once it is determined that the copy of the block is different from the reference copy using the process 330, the differences between the copy and the reference copy are stored. As a consequence, the blocks associated with the current snapshot may be built by applying the stored differences to the reference copy to recreate the copy. In some examples, because the differences may take less data to store than the complete block, the current snapshot may use less storage as a result. In some examples, the differences may be stored in another file system.

Use of the data structure that indicates the block characteristics (e.g., the block metafile 280) to traverse the blocks of the file system using the process 310 and the method 300 may be disadvantageous for several reasons. In some examples, many extra input/output (I/O) operations may be used to access the data structure. As shown in the examples of FIG. 2, the block metafile 280 is stored in the file system 200 just like other files. As a result, in order for the snapshot tool to access the block metafile 280, it may also read the block metafile 280 from the file system 200 using I/O operations that are separate from the I/O operations used to access the other blocks. In some examples, because I/O operations may incur significant overhead (e.g., when the persistent storage for the file system 280 includes a magnetic disk, seek and latency times to switch between the blocks and the block metafile 280 and back may be quite lengthy), these extra I/O operations may significantly slow down the creation of snapshots. In some examples, the number of extra I/O operations may be reduced using buffering, caching, and/or similar techniques, but because of the large size of the block metafile 280, the effects cannot be entirely removed in many instances.

In some examples, problems with or corruption in the block metafile 280 may adversely impact any use of the block metafile 280. In some examples, when the corruption in the block metafile 280 is not detected, the corruption may propagate to any resulting snapshot. In some examples, when incorrect level and/or type information is contained in the block metafile 280, blocks that should be included in a snapshot may be inadvertently omitted and/or blocks that are not part of a snapshot may be inadvertently included. In some examples, when the corruption in the block metafile 280 is detected, the taking of snapshots may be temporarily suspended. In some examples, a length of the temporary suspension may become excessive because it may take hours or longer to recreate the block metafile 280 depending upon the number of blocks in the corresponding file system.

According to some embodiments, the snapshot tool may be able to determine the block characteristics it uses, such as the level of a block and the type of data in the block, without using a data structure such as the block metafile 280. In some examples, the snapshot tool may be able to use some of the same mechanisms used by the file system to create and/or recreate the block metafile 280 because the blocks themselves may each include a minimum amount of information to determine block characteristics, such as an indirection level and type, for each block. In some examples, by relying only on the contents of the block itself, the disadvantages of the block metafile 280 may be avoided. In some examples, no extra I/O operations would be used to read the block metafile 280 and corruption in the block metafile 280 would not be a factor.

In some examples, indirect blocks (e.g., the indirect blocks 260) may include level identification fields that identify those blocks as indirect blocks. By using the level identification fields, the level of each of the blocks may be determined. In some examples, most, if not all, of the metadata blocks of interest to the snapshotting process further include unique patterns and/or type identification fields that are sufficient to identify blocks with the types of interest. In some examples, blocks that are not being used may also include a not-in-use field indicating that there is no data in the corresponding block.

As with any identification system, the effects of false-positives and false-negatives may be considered. In the proposed snapshot system, a false-positive would result in identifying an extra blocks for inclusion in the snapshot. Other than creating a snapshot that is larger than necessary, the inclusion of a limited number of extra blocks in the snapshot would generally be benign. Thus, as long as false-positives are benign, the blocks themselves may be relied upon to determine level and type information. In the proposed snapshot system, a false-negative would result in omitting a block from the snapshot that should be included. This would result in an incomplete snapshot, which would generally not be acceptable. Thus, if every block of interest to the snapshot tool includes the necessary block characteritics, then the snapshot can be implemented without the use of the block metafile 280.

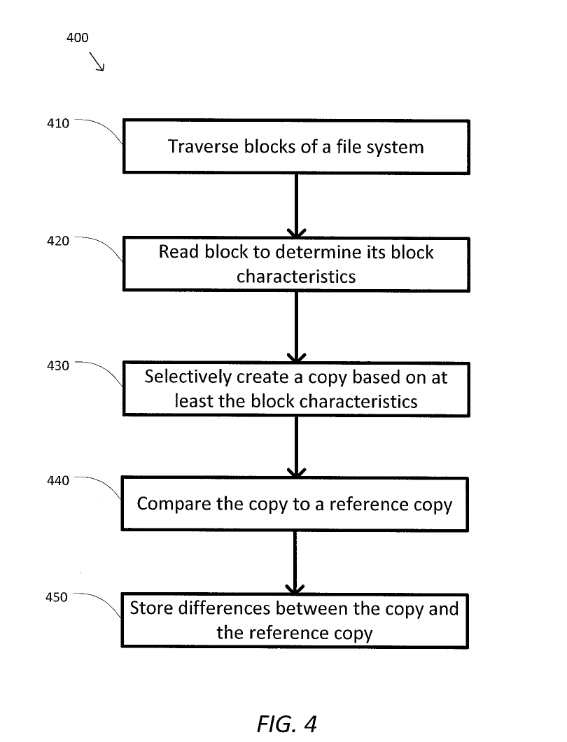

FIG. 4 is a simplified diagram showing a representative method 400 of snapshot creation without using a block metafile according to some embodiments. As shown in FIG. 4, the method 400 includes a process 410 for traversing blocks of a file system, a process 420 for reading a block to determine its block characteristics, a process 430 for selectively creating a copy based on at least the block characteristics, a process 440 for comparing the copy to a reference copy, and a process 450 for storing differences between the copy and the reference copy. According to certain embodiments, the method 400 of snapshot creation without using a block metafile can be performed using variations among the processes 410-450 as would be recognized by one of ordinary skill in the art. In some embodiments, one or more of the processes 410-450 of method 400 may be implemented, at least in part, in the form of executable code stored on non-transient, tangible, machine readable media that when run by one or more processors (e.g., one or more processors associated with the storage server 130 and/or one or more processors associated with the clients 110, 120) may cause the one or more processors to perform one or more of the processes 410-450. For example, in some embodiments one or more of the functional blocks 135 (FIG. 1) may perform method 400.

At the process 410, blocks of a file system are traversed. In some examples, a snapshot tool or utility may traverse the blocks in all or part of a file system in order to create a snapshot. In some examples, the snapshot tool or utility may be one of the clients 110, 120. In some examples, the snapshot tool or utility may be included as a service of the storage server 130 (e.g., using one or more of the functional blocks 135). By traversing the blocks, the snapshot tool or utility may identify those blocks that are a necessary part of a snapshot or a related data replication activity.

At the process 420, a block is read to determine its block characteristics. In some examples, the block characteristics may include an indirection level of the block, a type of data in the block, and/or whether the block is in use. In some examples, the level identification fields may be used to determine whether the block is an indirect block or a level zero data block. In some examples, the unique patterns and/or type identification fields may be used to determine whether the block contains data of a type that should be included in the snapshot. In some examples, the not-in-use field may further be used to determine whether the block is currently being used by the file system.

At the process 430, a copy based on at least the block characteristics is selectively created. Depending on the purpose of the snapshot or the data replication, it is not necessary to create a copy of each of the blocks in the file system. In some examples, the snapshot tool may selectively omit data and metadata from the snapshot based on the block characteristics, including the indirection level of the block, the type of data in the block, and/or whether the block is in use. The amount and type of data omitted from the snapshot depends on the purpose for which the snapshot is created. Because the blocks themselves include the block characteristics for each of the blocks, the process 430 may use the information contained therein to select which blocks are to be selectively copied as part of the snapshot.

At the process 440, the copy is compared to a reference copy. In some examples, it may be more efficient to record only the differences between a current snapshot and a previous snapshot. In order to determine whether there has been a change between the current snapshot and the previous snapshot, the copy of the block made during the process 430 is compared to a reference copy of the same block from the previous snapshot.

At the process 450, the differences between the copy and the reference copy are stored. Once it is determined that the copy of the block is different from the reference copy using the process 440, the differences between the copy and the reference copy are stored. As a consequence, the blocks associated with the current snapshot may be built by applying the stored differences to the reference copy to recreate the copy. In some examples, because the differences may take less data to store than the complete block, the current snapshot may use less storage as a result. In some examples, the differences may be stored in another file system.

As discussed above and further emphasized here, FIGS. 3 and 4 are merely examples, which should not unduly limit the scope of the claims. One of ordinary skill in the art would recognize many variations, alternatives, and modifications. According to some embodiments, the determination of the block characteristics, including the indirection level of the block, the type of data in the block, and/or whether the block is in use, may be used with other snapshot methods than those depicted in FIGS. 3 and 4.

According to some embodiments, the determination of the block characteristics, including the indirection level of the block, the type of data in the block, and/or whether the block is in use, may be used with tools and/or utilities other than snapshots and data replication. In some examples, a deduplication tool or utility may use the contents of a block to determine the block characteristics rather than rely on a data structure such as the block metafile 280. In some examples, the deduplication tool may deduplicate certain blocks in a file system and ignore others. For instnace, the deduplication tool may look for duplicate blocks among the level zero blocks containing regular, stream, and vdisk data while not removing duplicate blocks containing many of the other metadata types. As the deduplication tool traverses the file system, it compares the level zero blocks containing regular, stream, and vdisk data to other level zero blocks containing the same type of data. When two such blocks are found to contain a same contents, one of the blocks is removed from the file system and the references to the removed block are replaced with references to the remaining block. The contents of the two blocks may be compared using hashing values generated based on the contents or any other appropriate technique. Some embodiments may include the deduplication tool as part of a Write Anywhere File Layout (WAFL) file system.

Some embodiments of the storage server 130 and/or the clients 110, 120 may include non-transient, tangible, machine readable media that include executable code that when run by one or more processors may cause the one or more processors to perform the processes of methods 300 and/or 400 as described above. Some common forms of machine readable media that may include the processes of methods 300 and/or 400 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

According to one embodiment, a storage system includes one or more processors, a memory for storing instructions for the one or more processors, persistent storage, and a file system implemented in the persistent storage and storing data in the persistent storage using a plurality of blocks. When the stored instructions are executed by the one or more processors, the one or more processors are configured to traverse the plurality of blocks, read contents of a first block selected from the plurality of blocks, determine one or more characteristics of the first block from metadata within the block, and selectively perform or not perform a storage operation with respect to the first data block in response to determining the one or more characteristics.

According to another embodiment, a method of processing blocks in a storage system includes traversing a plurality of blocks of a file system stored in persistent storage of the storage system, reading contents of a first block selected from the plurality of blocks, determining one or more characteristics of the first block by reading metadata within the contents of the first block, the one or more characteristics identifying a type or an indirection level of the first block within a hierarchy of the file system, and selectively omitting further processing of the first block based on determining the one or more characteristics.

According to yet another embodiment, a non-transitory machine-readable medium comprising a first plurality of machine-readable instructions which when executed by one or more processors associated with a storage system are adapted to cause the one or more processors to perform a method including traversing a plurality of blocks of a file system stored in persistent storage of the storage system, reading contents of a first block selected from the plurality of blocks, determining at least one of an indirection level of the first block and a type of the first block based on information contained in the contents of the first block, determining whether the indirection level and the type satisfy a criterion, and omitting further processing of the first block when the indirection level or type do not satisfy the criterion.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A storage system comprising:
one or more processors;
a memory for storing instructions for the one or more processors;
persistent storage; and
a file system implemented in the persistent storage and storing data in the persistent storage using a plurality of blocks;
wherein when the stored instructions are executed by the one or more processors, the one or more processors are configured to:
traverse the plurality of blocks;
read contents of a first block selected from the plurality of blocks;
determine one or more characteristics of the first block from metadata within the contents of the first block; and
selectively perform or not perform a storage operation with respect to the first data block in response to determining the one or more characteristics.

2. The storage system of claim 1 wherein the storage operation is selected from a group consisting of a replication operation and a deduplication operation.

3. The storage system of claim 1 wherein the one or more characteristics include items selected from a group consisting of an indirection level, a block type, and an in-use indicator.

4. The storage system of claim 1 wherein in response to determining the one or more characteristics, the executed instructions further configure the one or more processors to:
copy the contents of the first block; and
store the copy in the file system or in another file system.

5. The storage system of claim 1 wherein in response to determining the one or more characteristics, the executed instructions further configure the one or more processors to:
copy the contents of the first block;
determine differences between the contents of the first block and a reference copy of the contents of the first block; and
store the differences between the contents of the first block and the reference copy of the contents of the first block.

6. The storage system of claim 1 wherein in response to determining the one or more characteristics, the executed instructions further configure the one or more processors to remove the first block from the file system when the contents of the first block are duplicated by contents of a second block stored in the file system.

7. The storage system of claim 1 wherein:
the one or more characteristic include an in-use indicator; and
the executed instructions further configure the one or more processors to omit further processing of the first block when the in-use indicator indicates that the first block is not in use.

8. The storage system of claim 1 wherein the one or more characteristics include an indirection level and the indirection level indicates whether the first block is a data block with a level of zero or an indirection block with a level greater than zero.

9. The storage system of claim 1 wherein the one or more characteristics include a block type and the block type includes at least one of regular, directory, stream, streamdir, xinode, volinfo, fsinfo, inofile, and vdisk.

10. A method of processing blocks in a storage system, the method comprising:
traversing a plurality of blocks of a file system stored in persistent storage of the storage system;
reading contents of a first block selected from the plurality of blocks;
determining one or more characteristics of the first block by reading metadata within the contents of the first block, the one or more characteristics identifying a type or an indirection level of the first block within a hierarchy of the file system; and
selectively further processing or not processing the first block based on determining the one or more characteristics.

11. The method of claim 10, further comprising based on determining the one or more characteristics:
copying the contents of the first block; and
storing the copy in the file system or in another file system.

12. The method of claim 10, further comprising based on determining the one or more characteristics:
copying the contents of the first block;
determining differences between the contents of the first block and a reference copy of the contents of the first block; and
storing the differences between the contents of the first block and the reference copy of the contents of the first block.

13. The method of claim 10, further comprising based on determining the one or more characteristics, removing the first block from the file system when the contents of the first block are duplicated by contents of a second block stored in the file system.

14. The method of claim 10 wherein:
the one or more characteristic include an in-use indicator; and
the method further comprises omitting further processing of the first block when the in-use indicator indicates that the first block is not in use.

15. The method of claim 10, further comprising determining the one or more characteristics without using a data structure that aggregates the one or more characteristics for two or more of the plurality of blocks.

16. The method of claim 15 wherein the data structure is stored in the file system using one or more files.

17. A non-transitory machine-readable medium comprising a first plurality of machine-readable instructions which when executed by one or more processors associated with a storage system are adapted to cause the one or more processors to perform a method comprising:
traversing a plurality of blocks of a file system stored in persistent storage of the storage system;
reading contents of a first block selected from the plurality of blocks;
determining at least one of an indirection level of the first block and a type of the first block based on information contained in the contents of the first block;
determining whether the indirection level and the type satisfy a criterion; and
selectively copying or deduplicating the first block in response to determining whether the criterion is satisfied.

18. The non-transitory machine-readable medium of claim 17, wherein the one or more processors perform the following actions when the indirection level and the type satisfy the criterion:
copying the contents of the first block; and
storing the copy.

19. The non-transitory machine-readable medium of claim 17, wherein the one or more processors perform the following actions when the indirection level and the type satisfy the criterion:
copying the contents of the first block;
determining differences between the contents of the first block and a reference copy of the contents of the first block; and
storing the differences between the contents of the first block and the reference copy of the contents of the first block.

20. The non-transitory machine-readable medium of claim 17, wherein the one or more processors perform the following action when the indirection level and the type satisfy the criterion:
removing the first block from the file system when the contents of the first block are duplicated by contents of a second block stored in the file system.
